(19) United States
(12) Patent Application Publication
(10) Pub. No.: US 2003/0173184 A1
(43) Pub. Date: Sep. 18, 2003

(54) Escalator gap safety system

(76) Inventor: Kollanparampil Kuruvilla Kuruvilla, Lansdale, PA (US)

Correspondence Address: Kollanparampil K. Kuruvilla, 133 A Dawn Drive, Lansdale, PA, 19446, US

(21) Appl. No.: 10/097,182

(22) Filed: Mar. 13, 2002

(51) Int. Cl. B66B 23/12

(52) U.S. Cl. 198/333

(57) ABSTRACT

A recess to the size to accommodate each moving stepend is provided for the existing skirt panel on either side of the steps. By extending the step ends to this recess the present dangerous gap found in between the steps and the skirt panel can be relocated away from the passenger's clothing's direct access thus avoiding any possible risk to life or health.

### BACKGROUND OF THE INVENTION

1. Field of the Invention

The present invention relates generally to safety systems and, more particularly, to an Escalator Safety system, hereinafter referred to as ES system.

2. Description of the Related Art

With the increased use of public and private transportation in our society, there has been a corresponding increase in accidents that occur to public and private transportation passengers. Perhaps the most traumatic of these accidents occur when a person travels on an escalator in a building or in an installation and thus becomes trapped by clothes etc, falling into the existing gap between the step ends and the skirt panels. This action often results in several deaths, injury, trauma, and physical disability. This fact often results in an increased number of deaths, injuries and cases of mental trauma to persons and fellow passengers.

While most people would never knowingly subject themselves to direct physical harm, sometimes carelessness and a preoccupation with traveling on escalators leads to distraction from the dangers. At this point the passenger must either rapidly move out of the way, without knowing any of his/her clothes end or shoe laces etc, are inside the gap, perhaps also causing injury and even death, or rely on numerous prior art safety devices, which may or may not be operational, to avoid injury. Actually, his/her chances of this danger are high. The present invention on the other hand would reduce this potential by providing no gaps between the step ends and the skirt panels for any direct fall into the gaps by relocating the said gap in a closed covered place within the recess on either side.

Numerous attempts have been made to correct for the foregoing problems. But nothing effective has been found out or implemented yet.

Consequently, a need has been felt for providing a method, which provides shifting of the gap away from the possible danger zone so that various forms of public and private transportation on escalators take due notice of the potential danger.

### SUMMARY OF INVENTION

It is therefore an object of the present invention to relocate the existing 3/16″ or so gap between the step ends and the skirt panels to a recess on either side, inside the skirt panel.

It is another object of the present invention to provide a recess of suitable dimensions, which allows for the visual gap between the step ends and the skirt panels be hidden by the top horizontal surface of the recess thus made.

It is yet another object of the present invention to allow for the existing gap be relocated to the said recess.

It is another object of the present invention to provide an ES system, which allows for retrofitting and ease of installation into existing structure on the escalator.

It is yet another feature of the present invention that to provide a recess on the skirt panel on either side of the moving steps so that the gap between the ends of the steps and the skirt panel is shifted into the recess thus created to avoid any such dangers by any clothing or parts of clothes entering the gap and pulled away causing injury or death.

### BRIEF DESCRIPTION OF THE DRAWING

The advantages and features of the present invention will become better understood with reference to the following more detailed description and claims taken in conjunction with the accompanying drawings, in which like elements are identified with like symbols, and in which:

FIG. 1 is a pictorial illustration of the existing system according to a preferred embodiment of the present invention;

FIG. 2 is a pictorial illustration of the proposed system according to a preferred embodiment of the present invention;

FIG. 3 is a front elevational view of the existing structure as seen on a single step.

FIG. 4 is a front elevational view of the newly proposed structure as seen on a single step.

### BRIEF DESCRIPTION OF OPERATION OF THE NEW SET UP

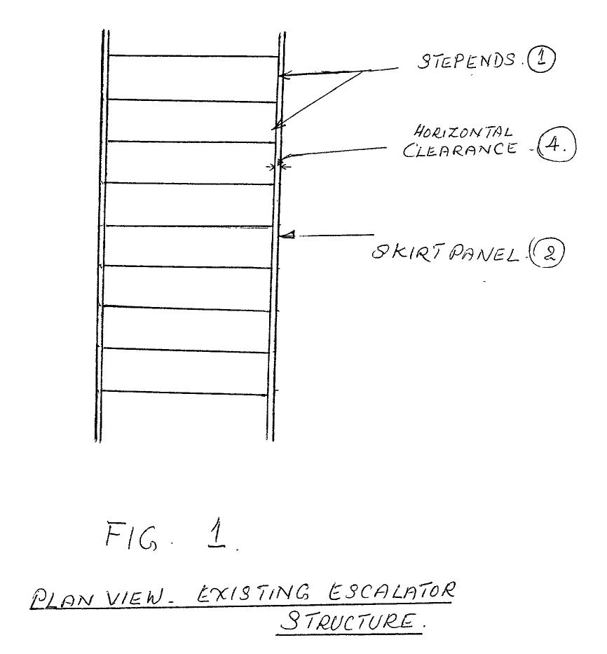

The step ends (1) now existing maintain a 3/16″ clearance (4) from the Skirt Panel (2) from either side, causing the prevailing alleged problems of danger of catching clothe ends etc. (FIG. 1)

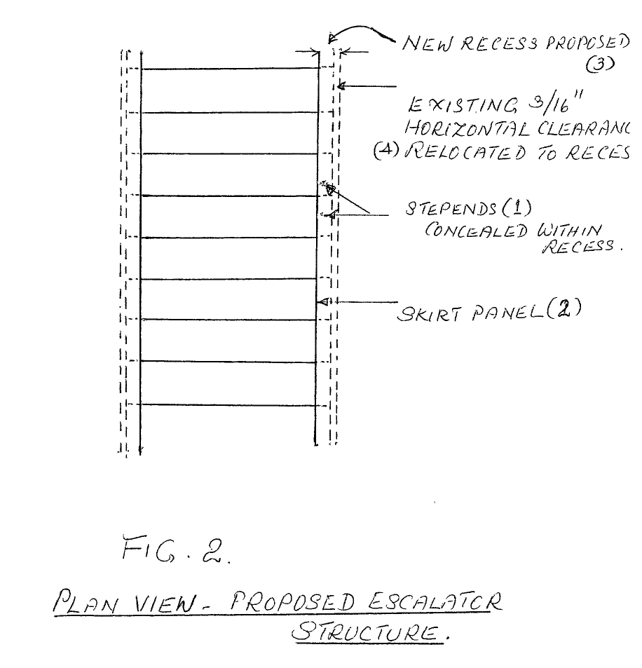

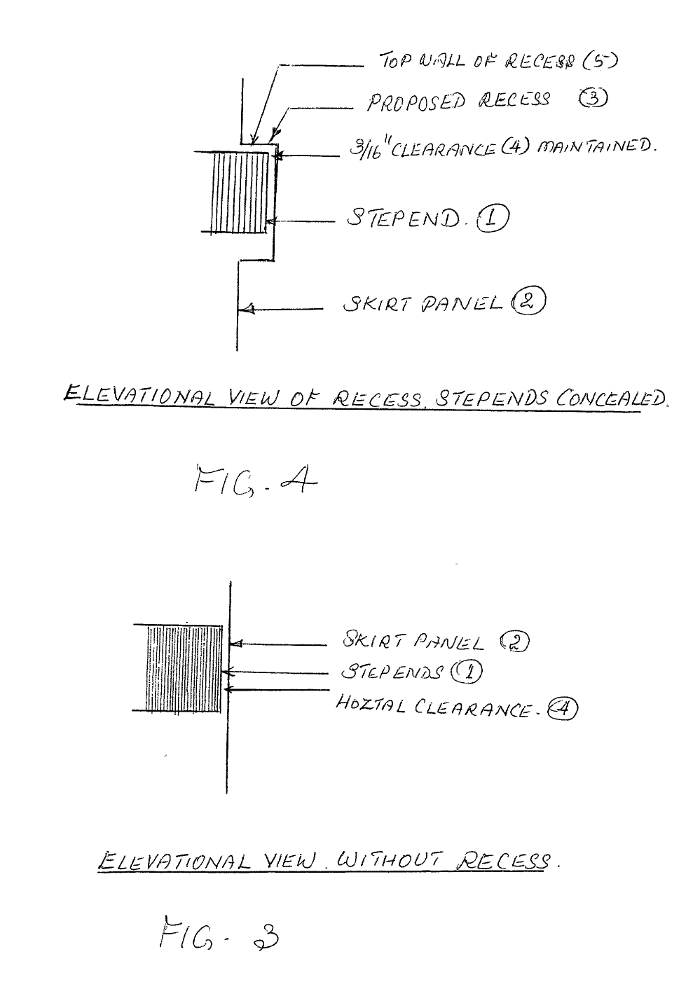

FIG. 2 represents the suggested improvements or modifications to the Escalator structure. The stepends (1) are shifted/relocated to a recess (3) newly designed on the Skirt Panel (2) thereby the 3/16″ clearance (4) be relocated thus concealing and covering it with the horizontal top surface wall of the recess (5), which maintains a clearance of 3/16″ vertically (6) from the top surface wall of the recess.

This design ensures the passengers a more safe travel on the escalator.

LEGEND

| | |
|---|---|
| Step Ends of the escalator | 1 |
| Skirt Panel | 2 |
| Recess Proposed on structure | |
| Existing Clearance between stepends and Skirt panel | 4 |
| Top Surface Wall of Recess | 5 |
| Vertical Clearance between Step and Top Wall of Recess | 6 |

2. Operation of the Preferred Embodiment

In operation, the present invention provides an additional level of accident avoidance to the everyday user of public and private transportation in a clear and concise manner without any input or training on the part of the user. The operation of the present invention with its preferred embodiment can be best be described in conjunction with the existing functional schematic or procedure.

The foregoing description of the preferred embodiment of the present invention has been presented for purposes of illustration and description. It is not intended to be exhaustive or to limit the present invention to the precise form disclosed, and obviously many modifications and variations are possible in light of the above teachings.

The preferred embodiment was chosen and described in order to best explain the principles of the present invention and its practical application to those persons skilled in the art, and thereby to enable those persons skilled in the art to best utilize the present invention in various embodiments and with various modifications as are suited to the particular use contemplated. It is intended that the scope of the present invention be broadly defined by the claims, which follow.

What is claimed is:

1. An ES system for use in conjunction with those public and private transportation on escalators, said ES system comprising:
A recess of suitable dimensions made in the skirt panel on either side of the moving steps can accommodate the gaps between the ends and the existing panels.

2. The ES system as described in claim 1, wherein said ends of steps be relocated to the recess thus provided on either side on the skirt panel.
